(19) United States
(12) Patent Application Publication
(10) Pub. No.: US 2009/0259348 A1
(43) Pub. Date: Oct. 15, 2009

(54) METHOD FOR CONTROLLING ROTATION SPEED OF FAN AND COMPUTER SYSTEM

(75) Inventor: Siao Jyuan Syu, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ASUSTek Computer Inc, Taipei (TW)

(21) Appl. No.: 12/327,452

(22) Filed: Dec. 3, 2008

(30) Foreign Application Priority Data
Apr. 14, 2008 (TW) 097113495

(51) Int. Cl. G05D 23/00

(52) U.S. Cl. 700/300

(57) ABSTRACT

The invention discloses a method for controlling a rotation speed of a fan and a computer system for performing the method. The method includes the following steps. (a) In an operating system, an operating interface is provided for adjusting the current rotation speed of the fan. (b) When the current rotation speed is lower than a predetermined rotation speed, or a current temperature is higher than a predetermined temperature, a warning message is shown in the operating system. (c) After the current rotation speed is readjusted, all processing programs continue to be run. Furthermore, the invention also provides a hot key function for users to conveniently adjust the rotation speed of the fan under the operating system.

### BACKGROUND OF THE INVENTION

1. Field of the Invention

The invention relates to a method for controlling a rotation speed of a fan and, more particularly, to a method adapted for a computer system for adjusting a rotation speed of a fan by users according to current circumstances and situations and application software thereof.

2. Description of the Prior Art

The temperature of a processor increases with acceleration of an operating speed, which causes the processor to become a “stove”. Processor designers face a big problem that how to make the processor operate safely, thus to improve reliability of a system and to prevent crash, blue screen, reboot and even burn of the processor, which are caused by overheating.

A motherboard is in charge of monitoring the temperature of the processor. If the motherboard monitors that the operating temperature of the processor exceeds a predetermined value in a basic input/output system (BIOS), it should accelerate a cooling fan, send an alarm and even automatically shut down the computer. Generally speaking, a fan is a root of computer noise. The higher the rotation speed of a fan is, the louder the noise generated by the fan is.

The temperature variation of the processor and corresponding rotation speeds of the fan are parameters set in a BIOS by motherboard manufacturers. In other words, the rotation speed of a fan of a conventional computer is automatically adjusted according to the temperature variation of the processor. When the temperature of the processor is in an allowable range, users cannot directly adjust the rotation speed of the fan down under an operating system to reduce noise. When the users feel that the processor temperature is too high and the rotation speed of the fan does not increase correspondingly, they also cannot directly adjust the rotation speed of the fan up under the operating system to accelerate heat dissipation.

Therefore, the invention provides a method for controlling a rotation speed of a fan to solve the above problem.

### SUMMARY OF THE INVENTION

One objective of the invention is to provide a method for controlling a rotation speed of a fan. Users can adjust the rotation speed of the fan in an operating system by themselves according to a current circumstance and situation.

According to an embodiment, the invention provides a set of application software which can be installed on an operating system. After the application software is installed, the method for controlling a rotation speed of a fan in the invention can be realized in the operating system.

In a practical application, the method for controlling a rotation speed of a fan includes the following steps. After the application software is installed, the application software provides an operating interface in an operating system for the users to adjust the current rotation speed of the fan. When the current rotation speed of the fan is lower than a predetermined rotation speed, or a current temperature of electronic components in a computer system is higher than a predetermined temperature, the application software shows a warning message in the operating system and suspends all processing programs. After the users readjust the current rotation speed of the fan, the application software allows the computer system to continue to run all the processing programs.

The invention also provides a hot key function for the users to call the operating interface to adjust the rotation speed of the fan in the operating system at any time. For example, a scroll wheel of a mouse may be set as a hot key. When the users want to adjust settings by themselves or a warning message appears, the users can directly click the scroll wheel of the mouse once. When the operating interface appears, the users move the mouse up and down or roll the scroll wheel back and forth to quickly adjust up or down the rotation speed of the fan.

Therefore, when the current rotation speed of the fan is not high enough for efficiently reducing the temperature of the electronic components, the application software of the invention tells the users about the current situation and setting values by a warning message. The users have to adjust the rotation speed of the fan before they continue to do current works. Thus, the electronic components are prevented from being damaged by overheating. Furthermore, when the temperature of the electronic components is in an allowable range, the users can directly adjust the rotation speed of the fan down in the operating system to reduce noise. In addition, the hot key function in the invention provides a more convenient adjusting mode for the users.

These and other features, aspects, and advantages of the current invention will become better understood with regard to the following description, appended claims, and accompanying drawings.

### BRIEF DESCRIPTION OF THE APPENDED DRAWINGS

FIG. 1 is a flowchart of a method for controlling a rotation speed of a fan according to an embodiment of the invention;

FIG. 2 is a schematic diagram of a main screen shown by an operating system;

FIG. 3 is a schematic diagram showing an operating interface in the main screen;

FIG. 4 is a schematic diagram showing how to use a hot key function to adjust a rotation speed of a fan;

FIG. 5 is a schematic diagram showing a warning message in the main screen;

FIG. 6 is a schematic diagram showing another warning message in the main screen; and

FIG. 7 is a functional block diagram of a computer system according to an embodiment of the invention.

### DETAILED DESCRIPTION OF THE INVENTION

The method for controlling a rotation speed of a fan in the invention allows users to directly adjust the rotation speed of the fan of a computer system under an operating system. The computer system includes necessary operating hardware and software components such as a central processing unit (CPU), a basic input/output system (BIOS), a random access memory (RAM), a read only memory (ROM), a motherboard, a power supply, a display panel, a backlight module and an operating system (OS). The functions of the above components are easy for people having ordinary skills in the art to attain and utilize. Therefore, they are not described hereinafter for a concise purpose.

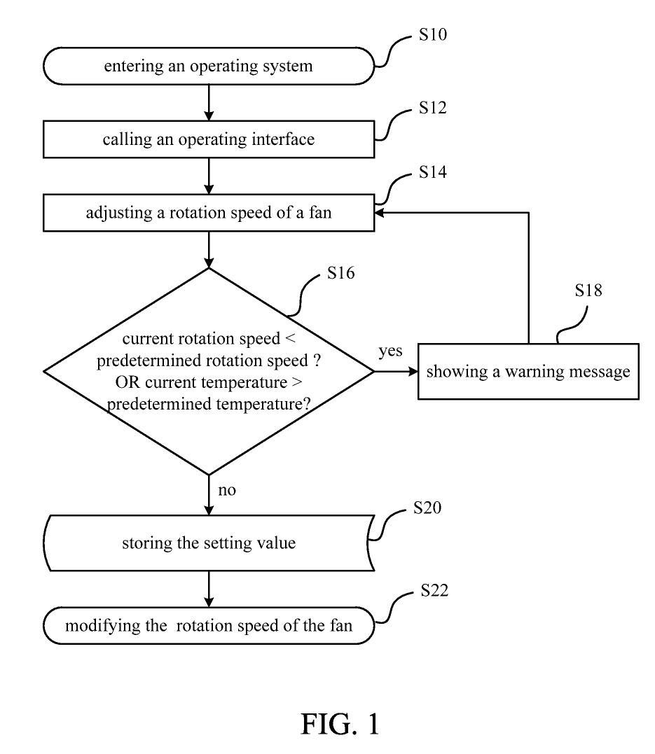

FIG. 1 is a flowchart of a method for controlling a rotation speed of a fan according to an embodiment of the invention. The method for controlling the rotation speed of the fan in the embodiment is realized by application software installed on the operating system. After the application software is installed, the operating system is entered (step S10). When a user wants to adjust the rotation speed of the fan, the user can call an operating interface on a main screen shown by the operating system (step S12) to adjust a current rotation speed of the fan (step S14). After the current rotation speed of the fan is adjusted, the application software may determine whether the current rotation speed is lower than a predetermined rotation speed, or whether a current temperature is higher than a predetermined temperature (step S16). If the current rotation speed is lower than the predetermined rotation speed, or the current temperature is higher than the predetermined temperature, the application software shows a warning message in the operating system (step S18), and then it requests the user to readjust the rotation speed of the fan (back to step S14). If the current rotation speed and the current temperature are in an allowable range, a current setting value is stored (step S20) and the rotation speed of the fan is modified (step S22).

In another embodiment, after the warning message is shown in the operating system, in the method for controlling the rotation speed of the fan in the embodiment, all processing programs are suspended to avoid increase of a system temperature.

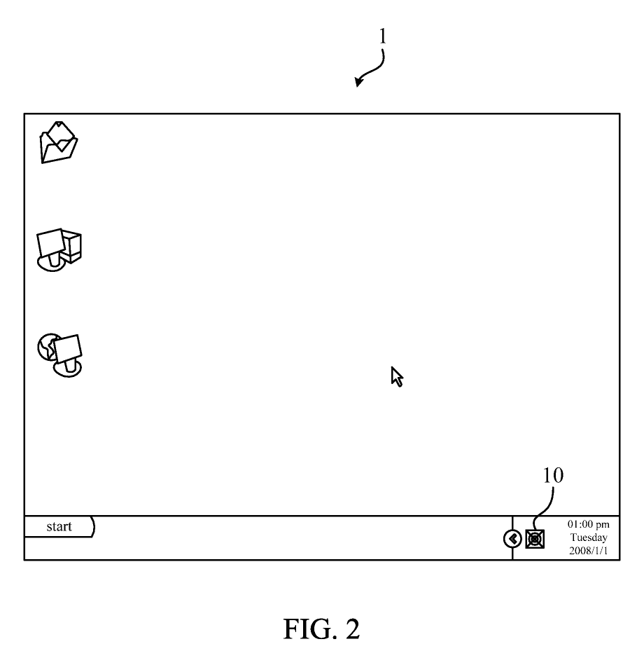

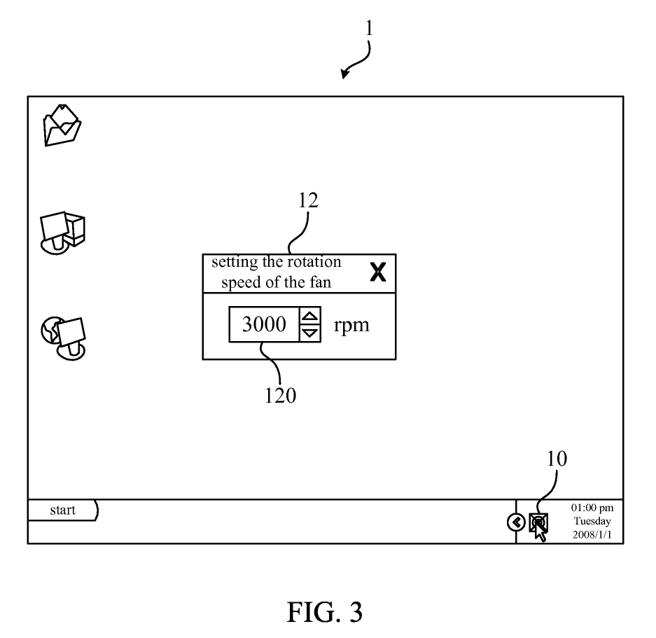

FIG. 2 is a schematic diagram of a main screen 1 shown by an operating system. FIG. 3 is a schematic diagram showing an operating interface 12 in the main screen 1. As shown in FIG. 2, after application software is installed, a corresponding icon 10 appears at a bottom right corner of the main screen 1. When a user wants to adjust the rotation speed of the fan, the user only needs to click the icon 10 to enable the operating interface 12, as shown in FIG. 3. When adjusting the rotation speed of the fan, the user may directly use a keyboard to input a rotation speed value in an input box 120 of the operating interface 12. The user may also use a mouse to click [symbol] to adjust the rotation speed up or click [symbol] to adjust the rotation speed down.

In another embodiment, when a user installs the application software of the invention, the user may select that the icon 10 does not show in the main screen 1, and the user may select to perform the method for controlling the rotation speed of the fan from a start menu.

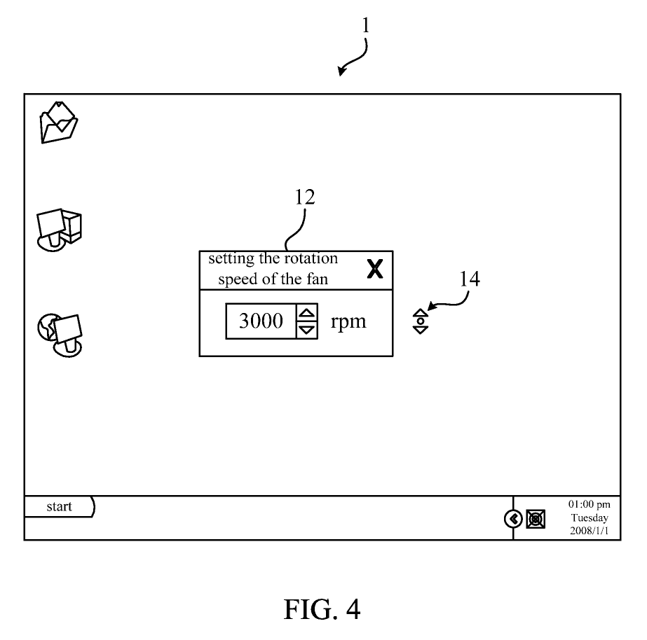

FIG. 4 is a schematic diagram showing how to use a hot key function to adjust a rotation speed of a fan. Furthermore, the method of the embodiment further has a hot key function for a user to call the operating interface 12 to adjust the rotation speed of the fan in the operating system at any time. For example, a scroll wheel of a mouse may be set as a hot key. When the user wants to adjust the setting by himself or herself, the user can directly click the scroll wheel of the mouse once. Then, the operating interface 12 and a control cursor 14 as shown in FIG. 4 appear in the main screen 1. At that moment, the user moves the mouse up and down, which quickly adjusts the rotation speed of the fan up or down. In addition, the invention also may has another design that when the operating interface 12 appears in the main screen 1, the user rolls the scroll wheel of the mouse back and forth to adjust the rotation speed of the fan according to a practical situation.

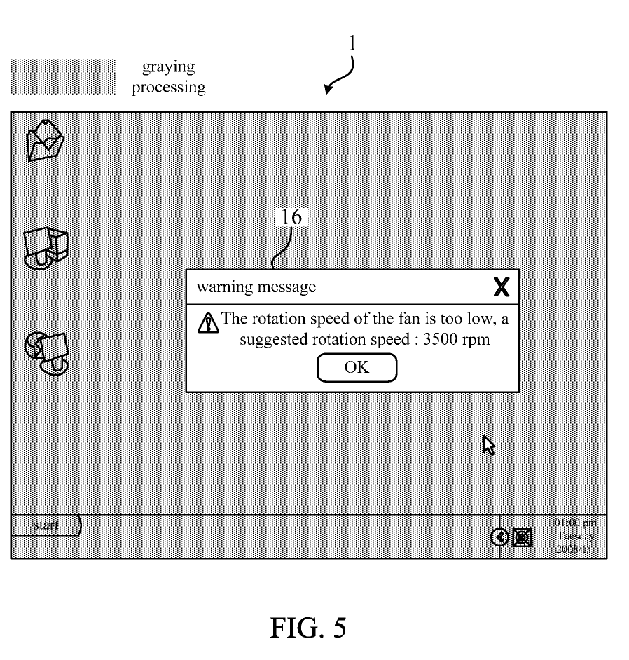

FIG. 5 is a schematic diagram showing a warning message 16 in the main screen 1. In a practical application, to prevent a user from adjusting a rotation speed of a fan to be too low to avoid damaging the electronic components, manufactures reset a minimum value of the rotation speed of the fan. When the rotation speed of the fan adjusted by the user is lower than a predetermined rotation speed, the application software shows the warning message 16 in the main screen 1 as shown in FIG. 5 to inform the user that the current rotation speed of the fan needs to be readjusted. Preferably, the warning message 16 may also show a suggested rotation speed to avoid repeated incorrect adjustment made by the user. In addition, when the warning message 16 appears in the main screen 1, at the same time, the application software performs a highlight processing for a background of the main screen 1 to remind the user of attentions.

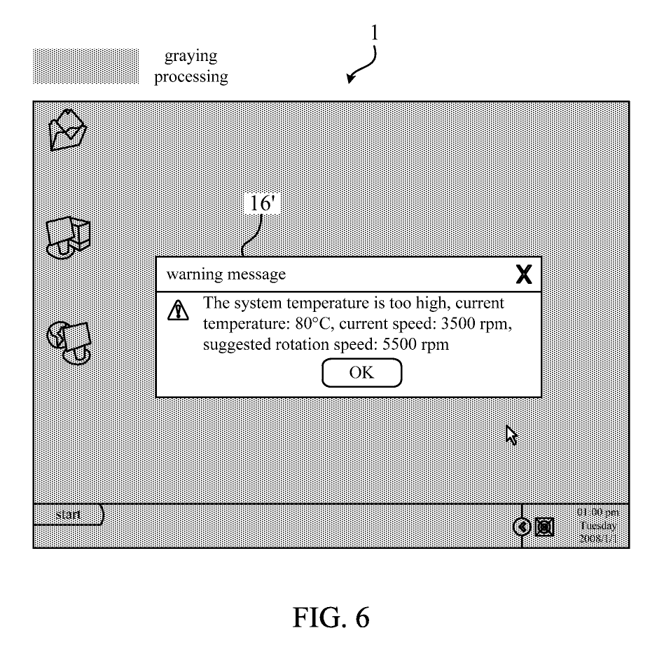

FIG. 6 is a schematic diagram showing another warning message 16′ in the main screen 1. In a practical application, when a rotation speed of a fan adjusted by a user cannot cool the system temperature efficiently, that is, the current temperature is higher than a predetermined allowable temperature set by manufactures, application software may show the warning message 16′ in the main screen 1 as shown in FIG. 6 to inform the user that the current rotation speed of the fan needs to be readjusted. Preferably, the warning message 16′ may also show a suggested rotation speed to avoid repeated incorrect adjustment made by the user. Furthermore, the warning message 16′ may also show the current rotation speed, the current temperature and other messages for the user to refer to. In addition, when the warning message 16′ appears in the main screen 1, at the same time, the application software performs a highlight processing for a background of the main screen 1 to remind the user of attentions, and the application software suspends all the processing programs to avoid increase of a system temperature. After the user adjusts the rotation speed of the fan, the original processing programs continue to be run.

According to the above descriptions, a control logic shown in FIG. 1 is realized by application software. The application software may be executed in a computer such as a laptop computer or a desktop computer. Every part or function of the control logic may be realized by software, hardware, or a combination of hardware and software. Furthermore, the control logic shown in FIG. 1 can be embodied in data stored in a computer readable storage media. The computer readable storage media may be a floppy disk, a hard disk, an optical disk, another magnetic or optical device or combination device thereof. The data representing instructions and stored by the computer readable storage media can be executed by the computer to generate control commands to allow a user to adjust the rotation speed of the fan directly in the operating system.

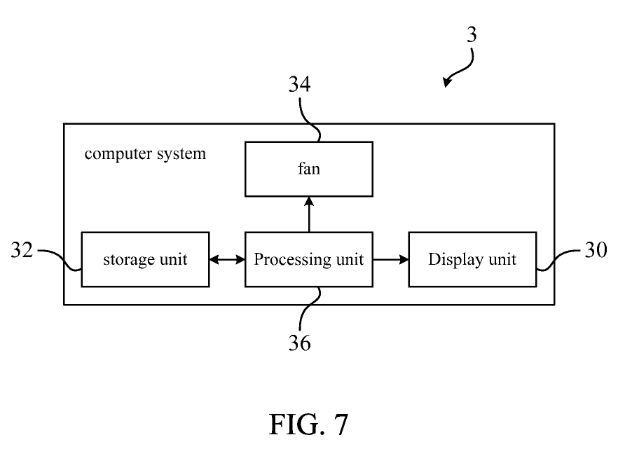

FIG. 7 is a functional block diagram of a computer system 3 according to an embodiment of the invention. The computer system 3 is used to perform the method for controlling the rotation speed of the fan as shown in FIG. 1. The computer system 3 includes a display unit 30, a storage unit 32, a fan 34, and a processing unit 36. The processing unit 36 is coupled with the display unit 30, the storage unit 32, and the fan 34. The display unit 30 is used to show the main screen 1 shown in FIG. 2 to FIG. 6. The storage unit 32 stores a set of instructions for performing the method for controlling the rotation speed of the fan as shown in FIG. 1. The fan 34 operates at a current rotation speed.

As shown in FIG. 2 and FIG. 3, the processing unit 36 executes the instructions of the storage unit 32 to provide the icon 10 and the operating interface 12 for adjusting the current rotation speed of the fan 34 in the main screen 1. Furthermore, the processing unit 36 can execute the instructions of the storage unit 32 to perform a hot key function to show the operating interface 12. In a practical application, the processing unit 26 can execute the instructions of the storage unit 32 to respond a click of a scroll wheel of a mouse, to perform the hot key function and to respond a movement of the mouse or a roll of the scroll wheel to adjust the current rotation speed of the fan 34.

As shown in FIG. 5 and FIG. 6, when the current rotation speed of the fan 34 is lower than a predetermined rotation speed, or a current temperature of the computer system 3 is higher than a predetermined temperature, the processing unit 36 executes the instructions of the storage unit 32 to show a warning message 16 or 16′ in the main screen 1. In a practical application, the processing unit 36 can execute the instructions of the storage unit 32 to show a suggested rotation speed, the current rotation speed, and the current temperature together in the main screen 1. Preferably, after the processing unit 36 shows the warning message 16 or 16′ in the main screen 1, all processing programs are suspended to avoid increase of a system temperature. After the current rotation speed of the fan 34 is readjusted, the processing unit 36 executes the instructions of the storage unit 32 to continue to run all the processing programs. Furthermore, when the current rotation speed of the fan 34 is lower than the predetermined rotation speed, or the current temperature of the computer system 3 is higher than the predetermined temperature, the processing unit 36 executes the instructions of the storage unit 32 to perform a highlight processing for a background of the main screen 1 to remind the user of attentions.

Compared with the prior art, according to the method for controlling the rotation speed of the fan and the computer system in the invention, when the temperature of the electronic components is in an allowable range, users can directly adjust the rotation speed of the fan down in the operating system to reduce noise. When the current rotation speed of the fan is not high enough for efficiently reducing the temperature of the electronic components, in the invention, users may be informed about current situations and setting values by a warning message. The users have to adjust the rotation speed of the fan before they continue to do current works, and then the electronic components can avoid being damaged by overheating. Furthermore, the invention further has a hot key function to provide a more convenient adjusting mode for the users.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for controlling a rotation speed of a fan, comprising the steps of:
providing an operating interface for adjusting a current rotation speed of the fan in an operating system;
when the current rotation speed is lower than a predetermined rotation speed, or a current temperature is higher than a predetermined temperature, showing a warning message in the operating system; and
continuing to run all processing programs after readjusting the current rotation speed.

2. The method for controlling the rotation speed of the fan according to claim 1, further comprising the step of:
when the current rotation speed is lower than the predetermined rotation speed, or the current temperature is higher than the predetermined temperature, performing a highlight processing for a background of the operating system.

3. The method for controlling the rotation speed of the fan according to claim 1, further comprising the step of:
when the warning message is shown, showing at least one of a suggested rotation speed, the current rotation speed, and the current temperature.

4. The method for controlling the rotation speed of the fan according to claim 1, further comprising the step of:
performing a hot key function to show the operating interface.

5. The method for controlling the rotation speed of the fan according to claim 4, further comprising the steps of:
responding a click of a scroll wheel of a mouse to perform the hot key function; and
responding a movement of the mouse or a roll of the scroll wheel to adjust the current rotation speed.

6. The method for controlling the rotation speed of the fan according to claim 1, wherein after the step of showing the warning message in the operating system, the method further comprises the step of suspending all the processing programs.

7. A computer system comprising:
a display unit showing a main screen;
a storage unit storing a set of instructions;
a fan operating at a current rotation speed; and
a processing unit coupled with the display unit, the storage unit, and the fan, the processing unit executing the instructions to provide an operating interface for adjusting the current rotation speed in the main screen, when the current rotation speed is lower than a predetermined rotation speed, or a current temperature is higher than a predetermined temperature, the processing unit executes the instructions to show a warning message in the main screen, and the processing unit executes the instructions to continue to run all processing programs after readjusting the current rotation speed.

8. The computer system according to claim 7, wherein when the current rotation speed is lower than the predetermined rotation speed, or the current temperature is higher than the predetermined temperature, the processing unit executes the instructions to perform a highlight processing for a background of the main screen.

9. The computer system according to claim 7, wherein when the warning message is shown, the processing unit executes the instructions to show at least one of a suggested rotation speed, the current rotation speed, and the current temperature in the main screen.

10. The computer system according to claim 7, wherein the processing unit executes the instructions to perform a hot key function to show the operating interface.

11. The computer system according to claim 10, wherein the processing unit executes the instructions to respond a click of a scroll wheel of a mouse, to perform the hot key function and to respond a movement of the mouse or a roll of the scroll wheel to adjust the current rotation speed.

12. The computer system according to claim 7, wherein the processing unit suspends all processing programs after showing the warning message in the main screen.
